(19) United States
(12) Patent Application Publication
(10) Pub. No.: US 2025/0222693 A1
(43) Pub. Date: Jul. 10, 2025

(54) LIQUID DISCHARGE HEAD AND RECORDING DEVICE

(71) Applicant: KYOCERA CORPORATION, Kyoto-shi, Kyoto (JP)

(72) Inventors: Naoki KOBAYASHI, Kirishima-shi, Kagoshima (JP); Kouki FURE, Kirishima-shi, Kagoshima (JP)

(21) Appl. No.: 18/847,685

(22) PCT Filed: Mar. 9, 2023
(86) PCT No.: PCT/JP2023/009164

§ 371 Date: Sep. 17, 2024

(30) Foreign Application Priority Data
Mar. 18, 2022 (JP) 2022-043885

(51) Int. Cl. B41J 2/14

(52) U.S. Cl. CPC B41J 2/14233; B41J 2002/14306; B41J 2002/14419

(57) ABSTRACT

A liquid discharge head includes a channel member including a first surface and a second surface located on the opposite side to the first surface, and a pressurizer located on the first surface. The channel member includes a plurality of discharge holes located at the second surface, a plurality of pressurizing chambers respectively connected to the plurality of discharge holes, a common channel commonly connected to the plurality of pressurizing chambers, and a damper chamber located adjacent to the common channel and separated from the common channel via a damper. The damper chamber has a thick portion in at least a portion of a bottom wall facing the damper, the thick portion being thicker than another portion.

### CROSS-REFERENCE TO RELATED APPLICATIONS

This application is national stage application of International Application No. PCT/JP2023/009164, filed on Mar. 9, 2023, which designates the United States, and which claims the benefit of priority from Japanese Patent Application No. 2022-043885, filed on Mar. 18, 2022.

### TECHNICAL FIELD

The disclosed embodiments relate to a liquid discharge head and a recording device.

### BACKGROUND OF INVENTION

Inkjet printers and inkjet plotters utilizing an inkjet recording method are known as printing devices. A liquid discharge head for discharging a liquid is mounted in such a printing device that uses an inkjet method.

In such a liquid discharge head, a damper chamber is provided under a manifold commonly connected to a plurality of discharge holes, and the manifold and the damper chamber are separated from each other via a damper, thereby suppressing pressure fluctuations of a liquid inside the manifold (for example, see Patent Document 1).

### CITATION LIST

### Patent Literature

Patent Document 1: JP 3951119 B

### SUMMARY

A liquid discharge head according to an aspect of an embodiment includes a channel member including a first surface and a second surface located on the opposite side to the first surface, and a pressurizer located on the first surface. The channel member includes a plurality of discharge holes located at the second surface, a plurality of pressurizing chambers respectively connected to the plurality of discharge holes, a common channel commonly connected to the plurality of pressurizing chambers, and a damper chamber located adjacent to the common channel and separated from the common channel via a damper. The damper chamber has a thick portion in at least a portion of a bottom wall facing the damper, the thick portion being thicker than another portion.

### BRIEF DESCRIPTION OF THE DRAWINGS

FIG. 1 is a front view schematically illustrating an overall front of a printer according to an embodiment.

FIG. 2 is a plan view schematically illustrating an overall plane of the printer according to the embodiment.

FIG. 3 is an exploded perspective view illustrating an overall configuration of a liquid discharge head according to the embodiment.

FIG. 4 is an enlarged plan view of a head body according to the embodiment.

FIG. 5 is a cross-sectional view taken along the line V-V illustrated in FIG. 4.

FIG. 6 is an enlarged plan view illustrating a configuration of main portions of the liquid discharge head according to the embodiment.

FIG. 7 is a cross-sectional view taken along the line VII-VII illustrated in FIG. 6.

FIG. 8 is a cross-sectional view taken along the line VIII-VIII illustrated in FIG. 6.

FIG. 9 is a diagram for describing a configuration of the channel member according to a first variation.

FIG. 10 is an enlarged plan view illustrating a portion of a lower surface of a cover spacer plate included in the channel member according to the first variation.

FIG. 11 is a diagram for describing a configuration of the channel member according to a second variation.

FIG. 12 is a plan view of the channel member according to a third variation.

### DESCRIPTION OF EMBODIMENTS

Embodiments of a liquid discharge head and a recording device disclosed in the present application will be described in detail below with reference to the accompanying drawings. Note that the present disclosure is not limited by the following embodiments. The drawings are schematic, and dimensional relationships between elements, proportions of the elements, and the like may differ from the actual ones. There may be differences between the drawings in terms of dimensional relationships, proportions, and the like.

In the following embodiments, expressions such as “constant”, “orthogonal”, “perpendicular”, and “parallel” may be used, but these expressions do not mean exactly “constant”, “orthogonal”, “perpendicular”, and “parallel”. In other words, it is assumed that the above expressions allow for deviations in manufacturing accuracy, installation accuracy, or the like.

### Configuration of Printer

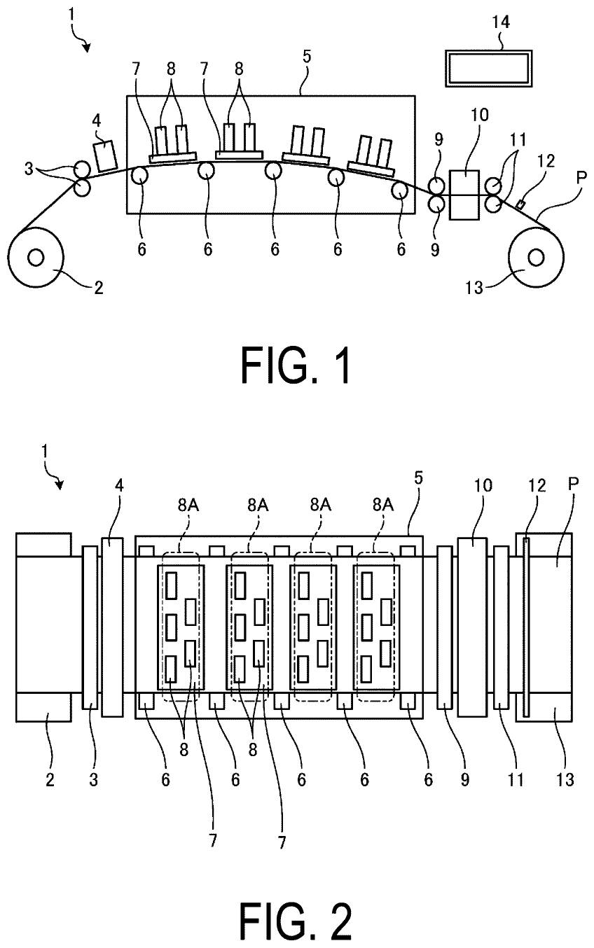

Using FIGS. 1 and 2, description will be given of an overview of a printer 1 serving as an example of a recording device according to an embodiment. FIG. 1 is a front view schematically illustrating an overall front of the printer 1 according to the embodiment. FIG. 2 is a plan view schematically illustrating an overall plane of the printer 1 according to the embodiment.

As illustrated in FIG. 1, the printer 1 includes a paper feed roller 2, guide rollers 3, an applicator 4, a head case 5, a plurality of transport rollers 6, a plurality of frames 7, a plurality of liquid discharge heads 8, transport rollers 9, a dryer 10, transport rollers 11, a sensor portion 12, and a collection roller 13.

The printer 1 further includes a controller 14 configured to control each portion of the printer 1. The controller 14 controls operations of the paper feed roller 2, the guide rollers 3, the applicator 4, the head case 5, the plurality of transport rollers 6, the plurality of frames 7, the plurality of liquid discharge heads 8, the transport rollers 9, the dryer 10, the transport rollers 11, the sensor portion 12, and the collection roller 13.

By depositing droplets on a printing sheet P, the printer 1 records images and characters on the printing sheet P. The printing sheet P is wound around the paper feed roller 2 in a drawable state before use. The printer 1 transports the printing sheet P from the paper feed roller 2 to the inside of the head case 5 via the guide rollers 3 and the applicator 4.

The applicator 4 uniformly applies a coating agent over the printing sheet P. In this way, a surface treatment can be performed on the printing sheet P, and the printing quality of the printer 1 can thus be improved.

The head case 5 houses the plurality of transport rollers 6, the plurality of frames 7, and the plurality of liquid discharge heads 8. The inside of the head case 5 is formed with a space separated from the outside except for portions connected to the outside such as portions from which the printing sheet P enters and exits the head case 5.

The controller 14 controls at least one of controllable factors of the internal space of the head case 5, such as temperature, humidity, and air pressure, as necessary. The transport rollers 6 transport the printing sheet P to the vicinity of the liquid discharge heads 8 inside the head case 5.

The frames 7 are rectangular flat plates and are positioned above and in close proximity to the printing sheet P transported by the transport rollers 6. As illustrated in FIG. 2, the plurality of frames 7 (e.g., four) are provided inside the head case 5 so that the longitudinal direction thereof is orthogonal to the transport direction of the printing sheet P. The plurality of frames 7 are disposed at predetermined intervals along the transport direction of the printing sheet P.

In the following description, the transport direction of the printing sheet P may be referred to as a “sub-scanning direction”, and the direction orthogonal to the sub-scanning direction and parallel to the printing sheet P may be referred to as a “main scanning direction”.

Each of the liquid discharge heads 8 is a so-called non-circulation type liquid discharge head that discharges a liquid supplied thereto. A liquid, for example, ink, is supplied to the liquid discharge head 8 from a liquid tank (not illustrated). The liquid discharge head 8 discharges the liquid supplied from the liquid tank.

The controller 14 controls the liquid discharge heads 8 based on data of an image, characters, or the like to discharge the liquid toward the printing sheet P. The distance between the liquid discharge heads 8 and the printing sheet P is, for example, approximately from 0.5 mm to 20 mm.

The liquid discharge head 8 are fixed to the frames 7. For example, both end portions of the liquid discharge heads 8 in the longitudinal direction are fixed to the frames 7. The liquid discharge heads 8 are fixed to the frames 7 such that the longitudinal direction of the liquid discharge heads 8 is parallel to the main scanning direction.

That is, the printer 1 according to the embodiment is a so-called line printer in which the liquid discharge heads 8 are fixed inside the printer 1. Note that the printer 1 according to the embodiment is not limited to the line printer and may also be a so-called serial printer.

The serial printer is a printer employing a method of alternately performing an operation of recording while moving the liquid discharge heads 8 so as to cause the liquid discharge heads 8 to reciprocate in a direction intersecting (e.g., substantially orthogonal to) the transport direction of the printing sheet P, and an operation of transporting the printing sheet P.

As illustrated in FIG. 2, a plurality of (for example, five) liquid discharge heads 8 are provided in one of the frames 7. FIG. 2 illustrates an example in which two of the liquid discharge heads 8 are disposed on the upstream side of the sub-scanning direction and three of the liquid discharge heads 8 are disposed on the downstream side of the sub-scanning direction, and the liquid discharge heads 8 are arranged such that the centers of the liquid discharge heads 8 do not overlap with each other in the sub-scanning direction.

The plurality of liquid discharge heads 8 provided in one of the frames 7 form a head group 8A. Four of the head groups 8A are positioned along the sub-scanning direction. The liquid discharge heads 8 belonging to the same head group 8A are supplied with ink of the same color. As a result, the printer 1 can perform printing with four colors of ink using the four head groups 8A.

The colors of the ink discharged from the respective head groups 8A are, for example, magenta (M), yellow (Y), cyan (C), and black (K). The controller 14 can print a color image on the printing sheet P by controlling the respective head groups 8A to discharge the plurality of colors of ink onto the printing sheet P.

Note that a coating agent may be discharged from the liquid discharge heads 8 onto the printing sheet P to perform a surface treatment on the printing sheet P.

The number of the liquid discharge heads 8 included in one of the head groups 8A and the number of the head groups 8A mounted in the printer 1 can be changed as appropriate in accordance with an object to be printed and printing conditions. For example, when the color to be printed on the printing sheet P is a single color and the printing range can be covered by one of the liquid discharge heads 8, only one of the liquid discharge heads 8 need be provided in the printer 1.

The printing sheet P on which the printing has been performed inside the head case 5 is transported to the outside of the head case 5 by the transport rollers 9 and passes through the inside of the dryer 10. The dryer 10 dries the printing sheet P on which the printing has been performed. The printing sheet P dried by the dryer 10 is transported by the transport rollers 11 and then collected by the collection roller 13.

In the printer 1, by drying the printing sheet P using the dryer 10, it is possible to suppress bonding between the printing sheets P taken up by the collection roller 13 in an overlapped manner, or rubbing of an undried liquid on the collection roller 13.

The sensor portion 12 includes a position sensor, a speed sensor, or a temperature sensor. Based on information from the sensor portion 12, the controller 14 can determine the state of each part of the printer 1 and control each portion of the printer 1.

In the above-described printer 1, the printing sheet P is used as the object to be printed (i.e., a recording medium), but the object to be printed in the printer 1 is not limited to the printing sheet P, and a rolled cloth or the like may be used as the object to be printed.

Instead of directly transporting the printing sheet P, the above-described printer 1 may have a configuration in which the printing sheet P is placed on a transporting belt and transported. By using the transporting belt, the printer 1 can use a sheet of paper, a cut cloth, wood, a tile, or the like as the object to be printed.

The above-described printer 1 may also discharge a liquid containing electrically conductive particles from the liquid discharge heads 8 to print a wiring pattern or the like of an electronic device.

The above-described printer 1 may also discharge a liquid containing a predetermined amount of a liquid chemical agent or of a liquid containing the chemical agent, from the liquid discharge heads 8 onto a reaction vessel or the like to produce chemicals.

The above-described printer 1 may also include a cleaner for cleaning the liquid discharge heads 8. The cleaner cleans the liquid discharge heads 8 by, for example, a wiping process or a capping process.

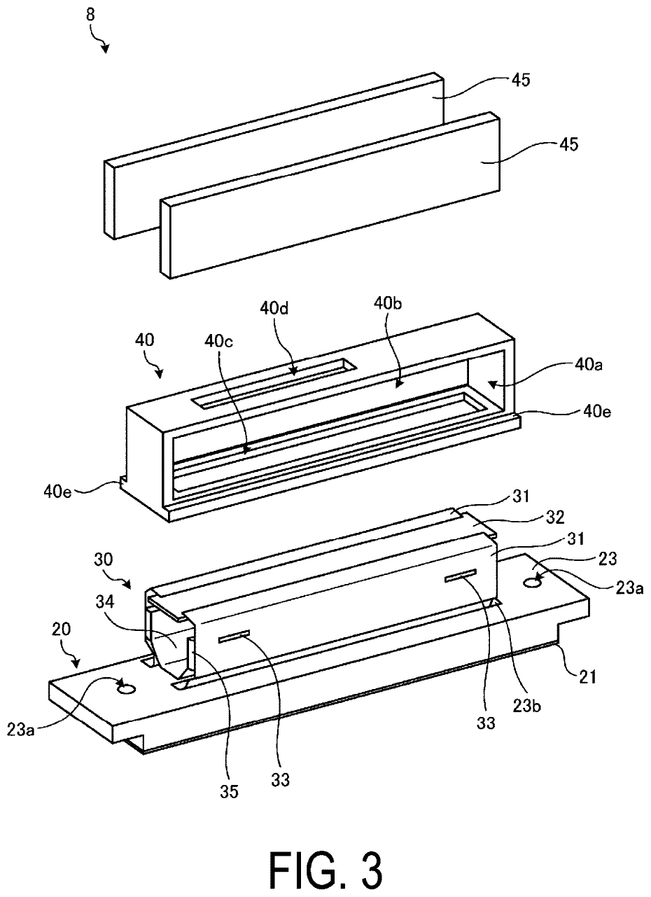

The wiping process is, for example, a process of removing a liquid attached to a second surface 21b (see FIG. 5) of a channel member 21 (see FIG. 3), which is an example of a surface of a portion from which the liquid is discharged, by rubbing the second surface 21bwith a flexible wiper.

The capping process is a process of unclogging a discharge hole 63 (see FIG. 5) by covering, with a cap, a portion from which the liquid is discharged and repeating the discharge of the liquid. First, the cap is provided to cover the second surface 21b of the channel member 21, which is an example of the portion from which the liquid is discharged (this process is referred to as capping). As a result, a substantially sealed space is formed between the second surface 21b and the cap. Subsequently, the discharge of the liquid is repeated in the sealed space. As a result, it is possible to remove a liquid having a viscosity higher than that of the liquid in a normal state, or foreign matter or the like that has clogged the discharge hole 63.

### Configuration of Liquid Discharge Head

Next, a configuration of the liquid discharge head 8 according to the embodiment will be described using FIG. 3. FIG. 3 is an exploded perspective view illustrating an overall configuration of the liquid discharge head 8 according to the embodiment.

The liquid discharge head 8 includes a head body 20, a wiring portion 30, a housing 40, and a pair of heat dissipation plates 45. The head body 20 includes the channel member 21, a piezoelectric actuator substrate 22 (see FIG. 5), and a reservoir 23.

In the following description, for convenience, a direction in which the head body 20 is provided in the liquid discharge head 8 may be represented as “lower”, and a direction in which the housing 40 is provided with respect to the head body 20 may be represented as “upper”.

The channel member 21 of the head body 20 has a substantially flat plate shape, and includes a first surface 21a (see FIG. 5), which is one main surface, and the second surface 21b (see FIG. 5) located on the opposite side to the first surface 21a. The first surface 21a includes an opening (not illustrated), and a liquid is supplied from the reservoir 23 to the inside of the channel member 21 through the opening.

A plurality of the discharge holes 63 (see FIG. 5) configured to discharge the liquid on the printing sheet P are provided at the second surface 21b. A channel through which the liquid flows from the first surface 21a to the second surface 21b is formed inside the channel member 21.

The piezoelectric actuator substrate 22 is located on the first surface 21a of the channel member 21. The piezoelectric actuator substrate 22 includes a plurality of displacement elements 70 (an example of a pressurizer) (see FIG. 5). The piezoelectric actuator substrate 22 is electrically connected to a flexible substrate 31 of the wiring portion 30.

The reservoir 23 is disposed on the piezoelectric actuator substrate 22. The reservoir 23 includes an opening 23a at each of both end portions thereof in the main scanning direction. The reservoir 23 includes a channel therein, and the liquid is supplied to the reservoir 23 from the outside through the openings 23a. The reservoir 23 supplies the liquid to the channel member 21. The reservoir 23 also stores the liquid to be supplied to the channel member 21.

The wiring portion 30 includes the flexible substrate 31, a wiring board 32, a plurality of driver ICs 33, a pressing member 34, and an elastic member 35. The flexible substrate 31 transmits, to the head body 20, a predetermined signal transmitted from the outside. Note that, as illustrated in FIG. 3, the liquid discharge head 8 according to the embodiment may include two of the flexible substrates 31.

The flexible substrate 31 includes one end portion electrically connected to the piezoelectric actuator substrate 22 of the head body 20. The other end portion of the flexible substrate 31 is drawn upward so as to be inserted through a slit 23b of the reservoir 23, and is electrically connected to the wiring board 32. As a result, the piezoelectric actuator substrate 22 of the head body 20 can be electrically connected to the outside.

The wiring board 32 is located above the head body 20. The wiring board 32 distributes signals to the plurality of driver ICs 33.

The plurality of driver ICs 33 are provided on one main surface of the flexible substrate 31. As illustrated in FIG. 3, in the liquid discharge head 8 according to the embodiment, two of the driver ICs 33 are provided on one of the flexible substrates 31, but the number of the driver ICs 33 provided on one of the flexible substrates 31 is not limited to two.

The driver IC 33 drives the piezoelectric actuator substrate 22 of the head body 20 based on a signal transmitted from the controller 14 (see FIG. 1). In this way, the driver IC 33 drives the liquid discharge head 8.

The pressing member 34 is substantially U-shaped in a cross-sectional view, and presses the driver IC 33 on the flexible substrate 31 toward the heat dissipation plate 45 from the inside. As a result, in the embodiment, heat generated when the driver IC 33 is driven can be efficiently dissipated to the outer heat dissipation plate 45.

The elastic member 35 is disposed so as to be in contact with an outer wall of a pressing portion (not illustrated) of the pressing member 34. By providing the elastic member 35, when the pressing member 34 presses the driver ICs 33, it is possible to reduce the likelihood of the pressing member 34 damaging the flexible substrate 31.

The elastic member 35 is made of, for example, double-sided foam tape or the like. For example, by using a non-silicon-based thermal conductive sheet as the elastic member 35, it is possible to improve the heat dissipating properties of the driver IC 33. Note that the elastic member 35 need not necessarily be provided.

The housing 40 is disposed on the head body 20 so as to cover the wiring portion 30. As a result, the housing 40 can seal the wiring portion 30. The housing 40 is made of, for example, a resin, a metal, or the like.

The housing 40 has a box shape elongated in the main scanning direction, and includes a first opening 40a and a second opening 40b at a pair of side surfaces facing each other along the main scanning direction, respectively. The housing 40 includes a third opening 40c at a lower surface thereof, and a fourth opening 40d at an upper surface thereof.

One of the heat dissipation plates 45 is disposed at the first opening 40a so as to close the first opening 40a, and the other one of the heat dissipation plates 45 is disposed at the second opening 40b so as to close the second opening 40b.

The heat dissipation plates 45 are provided so as to extend in the main scanning direction, and are made of a metal, an alloy, or the like having high heat dissipating properties. The heat dissipation plates 45 are provided so as to be in contact with the driver ICs 33, and have a function of dissipating the heat generated by the driver ICs 33.

The pair of heat dissipation plates 45 are fixed to the housing 40 by screws (not illustrated). Therefore, the housing 40 to which the heat dissipation plates 45 are fixed has a box shape in which the first opening 40a and the second opening 40b are closed and the third opening 40c and the fourth opening 40d are open.

The third opening 40c is provided so as to face the reservoir 23. The flexible substrate 31 and the pressing member 34 are inserted into the third opening 40c.

The fourth opening 40d is provided so that a connector (not illustrated) provided at the wiring board 32 can be inserted into the fourth opening 40d. It is preferable that a portion between the connector and the fourth opening 40d be sealed using a resin or the like. As a result, it is possible to suppress infiltration of a liquid, dust, or the like into the housing 40.

The housing 40 also includes heat insulating portions 40e. The heat insulating portions 40e are provided so as to be adjacent to the first opening 40a and the second opening 40b, respectively, and are provided so as to protrude outward from side surfaces of the housing 40 extending along the main scanning direction.

The heat insulating portions 40e are formed so as to extend in the main scanning direction. That is, the heat insulating portions 40e are located between the heat dissipation plates 45 and the head body 20. By providing the housing 40 with the heat insulating portions 40e in this manner, it is possible to suppress transfer of the heat generated by the driver ICs 33 through the heat dissipation plates 45 to the head body 20.

Note that FIG. 3 illustrates an example of the configuration of the liquid discharge head 8, and the liquid discharge head 8 may further include a member other than the members illustrated in FIG. 3.

### Configuration of Head Body

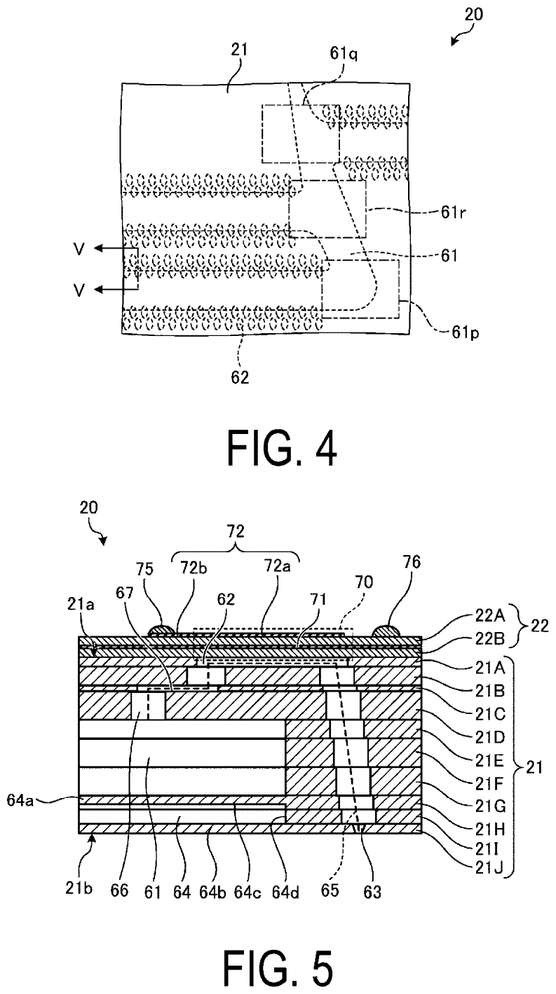

Next, a configuration of the head body 20 according to the embodiment will be described with reference to FIGS. 4 to 5. FIG. 4 is an enlarged plan view of the head body 20 according to the embodiment. FIG. 5 is a cross-sectional view taken along the line V-V illustrated in FIG. 4.

As illustrated in FIGS. 4 and 5, the head body 20 includes the channel member 21 and the piezoelectric actuator substrate 22. The channel member 21 includes a supply manifold 61, a plurality of pressurizing chambers 62, the plurality of discharge holes 63, and a damper chamber 64. The supply manifold 61 is an example of a common channel.

The plurality of pressurizing chambers 62 are connected to the supply manifold 61. The plurality of discharge holes 63 are each connected to corresponding one of the plurality of pressurizing chambers 62.

Each of the pressurizing chambers 62 is open to the first surface 21a (see FIG. 5) of the channel member 21. The first surface 21a of the channel member 21 includes an opening (not illustrated) in communication with the supply manifold 61. The liquid is supplied from the reservoir 23 (see FIG. 3) through the opening to the inside of the channel member 21.

The supply manifold 61 includes a portion in which a channel direction changes. It can be also said that the supply manifold 61 includes a portion in which a flow direction of a fluid changes. For example, as illustrated in FIG. 4, the supply manifold 61 includes, as the portions in which the channel direction changes, a bent portion 61p that is bent, a branching portion 61q that branches into a plurality of channels, and a merging portion 61r in which the plurality of channels merge. In this way, when the supply manifold 61 includes a plurality of sub-manifolds (portions to which the plurality of pressurizing chambers 62 are connected) extending along the longitudinal direction of the head body 20 and further includes the bent portion 61p, the branching portion 61q, and the merging portion 61r to which the plurality of sub-manifolds are connected, the bent portion 61p, the branching portion 61q, and the merging portion 61r are exemplified as the portions in which the channel direction changes.

In the channel member 21, the plurality of pressurizing chambers 62 are formed so as to expand two-dimensionally. Each of the pressurizing chambers 62 is open at the first surface 21a of the channel member 21, and is closed by the piezoelectric actuator substrate 22 being bonded to this first surface 21a.

Each of the discharge holes 63 is disposed at a position, of the channel member 21, avoiding a region, of the channel member 21, facing the supply manifold 61. That is, in a transparent view of the channel member 21 from the first surface 21a side, the discharge hole 63 does not overlap with the supply manifold 61.

In a plan view, the discharge holes 63 are disposed within a region in which the piezoelectric actuator substrate 22 is mounted. The discharge holes 63 occupy, as one group, a region having approximately the same size and shape as the size and shape of the piezoelectric actuator substrate 22.

By displacing the displacement elements 70 (see FIG. 5) of corresponding ones of the piezoelectric actuator substrates 22, droplets are discharged from the discharge hole 63.

The damper chamber 64 is located below the supply manifold 61. The damper chamber 64 is separated from the supply manifold 61 via a damper 64a. One side of the damper 64a faces the supply manifold 61 and the other side of the damper 64a faces the damper chamber 64. The damper 64a is positioned to face a bottom wall 64b of the damper chamber 64. As a result of a pressure applied from the supply manifold 61, the damper 64a can deform toward the bottom wall of the damper chamber 64. The damper 64a can dampen pressure fluctuations of the liquid inside the supply manifold 61, by vibrating in response to a pressure wave transmitted from the displacement element 70 to the supply manifold 61. Since the supply manifold 61 and the damper chamber 64 are separated from each other via the damper 64a, the pressure fluctuations of the liquid in the supply manifold 61 are suppressed. Note that the damper chamber 64 may be provided on the supply manifold 61 as long as the damper chamber 64 is adjacent to the supply manifold 61.

As illustrated in FIG. 5, the channel member 21 has a lamination structure in which a plurality of plates are laminated. As these plates, a cavity plate 21A, a base plate 21B, an aperture plate 21C, a supply plate 21D, manifold plates 21E, 21F, and 21G, a cover plate 21H, a cover spacer plate 211, and a nozzle plate 21J are provided in this order from the first surface 21a side of the channel member 21.

A large number of holes are formed in the plates constituting the channel member 21. The thickness of each of the plates is approximately from 10 μm to 300 μm. As a result, the precision with which holes are formed can be increased. The plates are aligned and laminated such that the holes communicate with each other to form a predetermined channel. For example, the manifold plates (an example of a first plate) 21E, 21F, and 21G are laminated so that the holes are in communication with each other to form the supply manifold 61.

In the plates constituting the channel member 21, a recessed portion and a hole are formed to form the damper chamber 64. For example, the cover plate (an example of a second plate) 21H includes a recessed portion 64c. The recessed portion 64c is a portion of the damper chamber 64 and located at a position corresponding to the supply manifold 61 on a surface of the cover plate 21H on the opposite side to a contact surface thereof with the manifold plates 21E, 21F, and 21G. The cover spacer plate (an example of a third plate) 211 includes a hole 64d that forms the damper chamber 64 together with the recessed portion 64c. The nozzle plate (an example of a fourth plate) 21J seals the hole 64d and forms the bottom wall 64b of the damper chamber 64. The damper 64a is formed by a remaining portion of the cover plate 21H remaining at the position of the recessed portion 64c in the thickness direction of the cover plate 21H. In this way, the recessed portion 64c and the damper 64a can be simultaneously formed by half-etching the cover plate 21H.

In the channel member 21, the supply manifold 61 and the discharge hole 63 are connected by an individual channel 65. The supply manifold 61 is located at the second surface 21b side inside the channel member 21, and the discharge hole 63 is located at the second surface 21b of the channel member 21.

The individual channel 65 includes the pressurizing chamber 62 and an individual supply channel 66. The pressurizing chamber 62 is located at the first surface 21a of the channel member 21, and the individual supply channel 66 is a channel connecting the supply manifold 61 and the pressurizing chamber 62.

The individual supply channel 66 includes an aperture 67 having a narrower width than the width of the other portion. Since the aperture 67 is narrower than the other portion of the individual supply channel 66, the aperture 67 has a high channel resistance. As described above, when the channel resistance of the aperture 67 is high, the pressure generated in the pressurizing chamber 62 hardly escapes to the supply manifold 61.

The piezoelectric actuator substrate 22 includes piezoelectric ceramic layers 22A and 22B, a common electrode 71, individual electrodes 72, a connection electrode 75, a dummy connection electrode 76, and a surface electrode (not illustrated).

The piezoelectric actuator substrate 22 includes the piezoelectric ceramic layer 22B, the common electrode 71, the piezoelectric ceramic layer 22A, and the individual electrodes 72 laminated in this order.

Both the piezoelectric ceramic layers 22A and 22B each extend over the first surface 21a of the channel member 21 so as to extend across the plurality of pressurizing chambers 62. The piezoelectric ceramic layers 22A and 22B each have a thickness of approximately 20 μm. For example, the piezoelectric ceramic layers 22A and 22B are made of a lead zirconate titanate (PZT)-based ceramic material having ferroelectricity.

The common electrode 71 is formed over substantially the entire surface in a surface direction of a region between the piezoelectric ceramic layer 22A and the piezoelectric ceramic layer 22B. That is, the common electrode 71 overlaps all the pressurizing chambers 62 in the region facing the piezoelectric actuator substrate 22.

The common electrode 71 has a thickness of approximately 2 μm. For example, the common electrode 71 is made of a metal material such as an Ag-Pd based material.

The individual electrodes 72 include a body electrode 72a and a drawn electrode 72b. The body electrode 72a is located in a region, facing the pressurizing chamber 62, on the piezoelectric ceramic layer 22A. The body electrode 72a is slightly smaller than the pressurizing chamber 62, and has a shape substantially similar to that of the pressurizing chamber 62.

The drawn electrode 72b is drawn out from the body electrode 72a to the outside of the region facing the pressurizing chamber 62. The individual electrodes 72 are made of, for example, a metal material such as an Au-based material.

The connection electrode 75 is located on the drawn electrode 72b, and is formed to have a convex shape with a thickness of approximately 15 μm. The connection electrode 75 is electrically connected to an electrode provided at the flexible substrate 31 (see FIG. 3). The connection electrode 75 is made of, for example, silver-palladium-containing glass frit.

The dummy connection electrode 76 is located on the piezoelectric ceramic layer 22A so as not to overlap with various electrodes such as the individual electrodes 72. The dummy connection electrode 76 connects the piezoelectric actuator substrate 22 and the flexible substrate 31 to increase connection strength.

The dummy connection electrode 76 makes distribution of contact positions between the piezoelectric actuator substrate 22 and the piezoelectric actuator substrate 22 uniform, and stabilizes electrical connection. The dummy connection electrode 76 is preferably made of a material equivalent to that of the connection electrode 75, and is preferably formed in a process equivalent to that of the connection electrode 75.

The surface electrode is located on the piezoelectric ceramic layer 22A while avoiding the individual electrodes 72. The surface electrode is connected to the common electrode 71 via a via hole formed in the piezoelectric ceramic layer 22B. In this way, the surface electrode is grounded and maintained at the ground potential. The surface electrode is preferably made of a material equivalent to that of the individual electrodes 72, and is preferably formed in a process equivalent to that of the individual electrodes 72.

A plurality of the individual electrodes 72 are electrically connected individually to the controller 14 (see FIG. 1) each via the flexible substrate 31 and the wiring, so that the potential thereof is individually controlled. When the individual electrodes 72 and the common electrode 71 are set to different potentials and an electric field is applied in the polarization direction of the piezoelectric ceramic layer 22A, a portion applied with the electric field in the piezoelectric ceramic layer 22A operates as an active portion that is distorted by the piezoelectric effect.

That is, portions, facing the pressurizing chamber 62, of the individual electrodes 72, the piezoelectric ceramic layer 22A, and the common electrode 71 in the piezoelectric actuator substrate 22 constitute the displacement element 70. When the displacement element 70 undergoes unimorph deformation, the pressurizing chamber 62 is pressed, and the liquid is discharged from the discharge hole 63.

### Configuration of Liquid Discharge Head

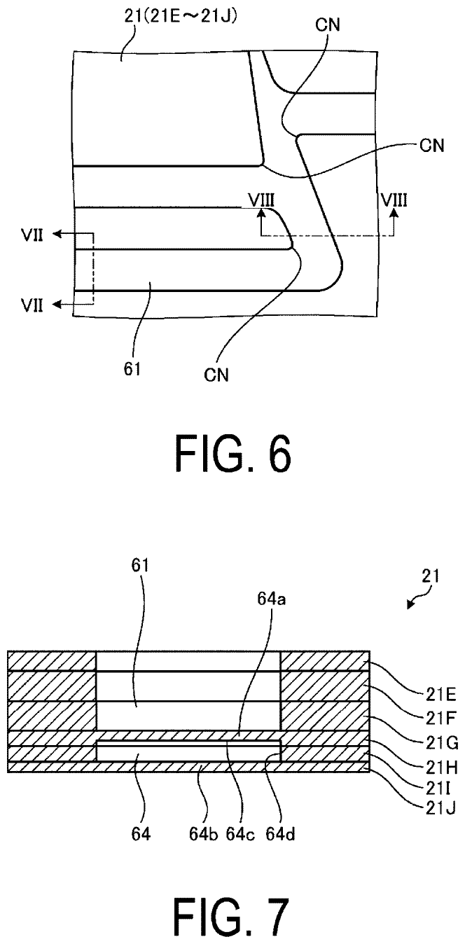

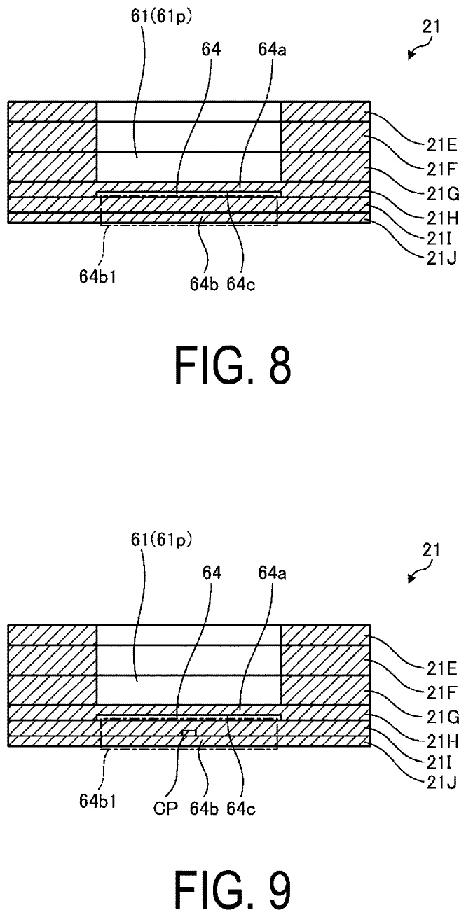

A configuration of main portions of the liquid discharge head 8 according to the embodiment will be described with reference to FIGS. 6 and 8. FIG. 6 is an enlarged plan view illustrating a configuration of the main portions of the liquid discharge head 8 according to the embodiment. In FIG. 6, of the plates constituting the channel member 21, the manifold plates 21E, 21F, and 21G, the cover plate 21H, the cover spacer plate 211, and the nozzle plate 21J are illustrated, and the other plates are omitted.

As described above, the supply manifold 61 includes the bent portion 61p, the branching portion 61q, and the merging portion 61r as the portions in which the channel direction changes (see FIG. 4). The damper chamber 64 separated from the supply manifold 61 via the damper 64a is located below the supply manifold 61 (see FIG. 5).

As illustrated in FIG. 6, sidewall surfaces of the portions in which the channel direction of the supply manifold 61 changes (the bent portion 61p, the branching portion 61q, and the merging portion 61r) each include a corner portion CN having an acute angle in a plan view.

FIG. 7 is a cross-sectional view taken along the line VII-VII illustrated in FIG. 6. FIG. 8 is a cross-sectional view taken along the line VIII-VIII illustrated in FIG. 6. FIG. 7 illustrates a cross section of a portion in which the channel direction of the supply manifold 61 does not change, and FIG. 8 illustrates a cross section of the bent portion 61p in which the channel direction of the supply manifold 61 changes. Since cross sections of the branching portion 61q and the merging portion 61r are the same as the cross section of the bent portion 61p, description thereof will be omitted.

As illustrated in FIGS. 7 and 8, of the damper chamber 64, at least a portion of the bottom wall 64b facing the damper 64a includes a thick portion 64b1. More specifically, the damper chamber 64 includes the thick portion 64b1 that is thicker than another portion, at a section corresponding to at least the portion, (bent portion 61p) in which the channel direction of the supply manifold 61 changes, of the bottom wall 64b facing the damper 64a. The other portion is a section corresponding to a portion, of the bottom wall 64b, in which the channel direction of the supply manifold 61 does not change. The distance between the thick portion 64b1 of the bottom wall 64b and the damper 64a is smaller than the distance between the other portion of the bottom wall 64b and the damper 64a.

Since the damper chamber 64 includes the thick portion 64b1 in the bottom wall 64b, when the damper 64a deforms in response to the pressure fluctuation of the liquid in the portion (bent portion 61p) in which the channel direction of the supply manifold 61 changes, the deformed damper 64a and the thick portion 64b1 come into contact with each other. Thus, even if the pressure fluctuation of the liquid in the portion (bent portion 61p) in which the channel direction of the supply manifold 61 changes becomes large, it is possible to restrict the deformation of the damper 64a, and as a result, it is possible to suppress the breakage of the damper 64a. In particular, since the sidewall surface of the supply manifold 61 includes the corner portion CN having an acute angle (see FIG. 6), stress is concentrated on the damper 64a immediately below the corner portion CN, and the damper 64a is likely to be damaged. In contrast, in the present embodiment, since the thick portion 64b1 restricts the deformation of the damper 64a, the concentration of stress on the damper 64a immediately below the corner portion CN is alleviated, and it is thus possible to suppress the breakage of the damper 64a immediately below the corner portion CN.

The thick portion 64b1 is formed by overlapping a region of the cover spacer plate 211 excluding the hole 64d with the nozzle plate 21J. As a result, the rigidity of the thick portion 64b1 is improved.

### Variations

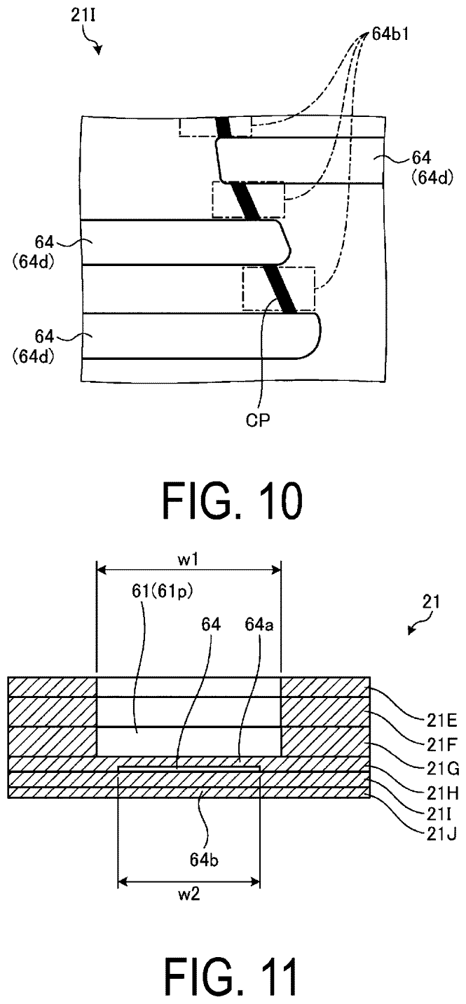

FIG. 9 is a diagram for describing a configuration of the channel member 21 according to a first variation. FIG. 10 is an enlarged plan view illustrating a portion of a lower surface (contact surface with the nozzle plate 21J) of the cover spacer plate 211 included in the channel member 21 according to the first variation. Note that FIG. 9 is a cross-sectional view taken along the line VIII-VIII illustrated FIG. 6.

As illustrated in FIGS. 9 and 10, in the channel member 21 according to the first variation, the damper chamber 64 is divided into a plurality of sections by the thick portion 64b1. The thick portion 64b1 has a communication path CP that causes adjacent sections of the damper chamber 64 to be in communication with each other. The communication path CP is, for example, a groove formed by half-etching the lower surface of the cover spacer plate 21I (the contact surface with the nozzle plate 21J). Since the thick portion 64b1 includes the communication path CP, the flow of air between the adjacent sections of the damper chamber 64 is not hindered. Therefore, it is possible to smooth out the vibrations of the damper 64a for damping the pressure fluctuations of the liquid in the supply manifold 61.

FIG. 11 is a diagram for describing a configuration of the channel member 21 according to a second variation. Note that FIG. 11 is a cross-sectional view taken along the line VIII-VIII illustrated in FIG. 6.

As illustrated in FIG. 11, in the channel member 21 according to the second variation, a width w1 of the bent portion 61p of the supply manifolds 61 is larger than a width w2 of a region, corresponding to the bent portion 61p, of the damper chamber 64 and the damper 64a. In this way, end portions of the damper 64a are positioned on the inner side of the sidewall surfaces of the bent portion 61p, and the concentration of stress on a lower portion of a sidewall of the bent portion 61p caused by the deformation of the damper 64a is alleviated. As a result, separation of the plates (the manifold plate 21G and the cover plate 21H) at the lower portion of the sidewall of the bent portion 61p is suppressed.

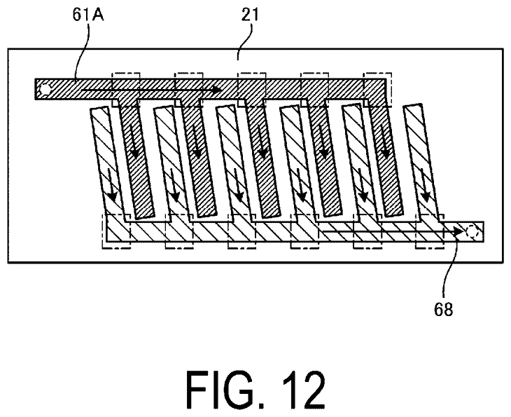

FIG. 12 is a plan view of the channel member 21 according to a third variation. The channel member 21 illustrated in FIG. 12 can be applied to the liquid discharge head 8 of a circulation type, which discharges a liquid while circulating the liquid inside the liquid discharge head 8. The channel member 21 illustrated in FIG. 12 includes a supply manifold 61A and a collection manifold 68. Although not illustrated, the channel member 21 according to the third variation includes a plurality of pressurizing chambers, a plurality of discharge holes, and damper chambers, similarly to the channel member 21 according to the embodiment. The plurality of pressurizing chambers are connected to the supply manifold 61A and the collection manifold 68. The supply manifold 61A and the collection manifold 68 are each an example of the common channel.

Each of the supply manifold 61A and the collection manifold 68 includes the portions in which the channel direction changes (that is, the bent portion, the branching portion, and the merging portion). In the example illustrated in FIG. 4, the portions in which the channel direction of the supply manifold 61A or the collection manifold 68 change (that is, the bent portion, the branching portion, and the merging portion) are indicated by frames of alternate long and short dashed lines.

The damper chamber separated from the supply manifold 61A via a damper is located below the supply manifold 61A. The damper chamber separated from the collection manifold 68 via the damper is located in the collection manifold 68. Each of the damper chambers includes a thick portion that is thicker than the other portion, at sections corresponding to at least the portions (that is, the bent portion, the branching portion, and the merging portion), in which the channel direction of the supply manifold 61A or the collection manifold 68 change, of a bottom wall facing the damper. As a result, in the third variation, similarly to the embodiment, it is possible to suppress the breakage of the damper.

As described above, a liquid discharge head (e.g., the liquid discharge head 8) according to an embodiment includes a channel member (e.g., the channel member 21) including a first surface (e.g., the first surface 21a) and a second surface (e.g., the second surface 21b) located on the opposite side to the first surface, and a pressurizer (e.g., the displacement element 70) located on the first surface. The channel member includes a plurality of discharge holes (e.g., the plurality of discharge holes) located at the second surface, a plurality of pressurizing chambers (e.g., the plurality of pressurizing chambers 62) respectively connected to the plurality of discharge holes, a common channel (e.g., the supply manifold 61) commonly connected to the plurality of pressurizing chambers, and a damper chamber (e.g., the damper chamber 64) located adjacent to the common channel and separated from the common channel via a damper (e.g., the damper 64a). The damper chamber has a thick portion (e.g., the thick portion 64b1) in at least a portion of a bottom wall (e.g., the bottom wall 64b) facing the damper, the thick portion being thicker than another portion. As a result, according to the liquid discharge head of the embodiment, the breakage of the damper can be suppressed. Since the thick portion is only partially provided in the damper chamber and not provided in another portion, the damper is less likely to be damaged and can also be made deformable.

A sidewall surface of the portion in which the channel direction of the common channel changes may include a corner portion having an acute angle. As a result, according to the liquid discharge head of the embodiment, even when the sidewall surface of the portion in which the channel direction of the common channel changes includes the corner portion having the acute angle, it is possible to suppress the breakage of the damper immediately below the corner portion.

The common channels may intersect each other in the portion in which the channel direction of the common channel changes. As a result, according to the liquid discharge head of the embodiment, even when the common channels intersect each other, it is possible to suppress the breakage of the damper.

The damper chamber may be divided into a plurality of sections by the thick portion. The thick portion may include a communication path (e.g., the communication path CP) configured to cause adjacent sections, of the plurality of sections of the damper chamber, to be in communication with each other. As a result, according to the liquid discharge head of the embodiment, since the flow of air between the adjacent sections of the damper chamber is not hindered, it is possible to smooth out the vibrations of the damper for damping the pressure fluctuations of the liquid in the supply manifold.

A portion in which a channel direction of the common channel changes may be a bent portion in which the common channel is bent. The width of the bent portion may be larger than the width of a region, of the damper chamber and the damper, corresponding to the bent portion. As a result, according to the liquid discharge head of the embodiment, the concentration of stress on a lower portion of a sidewall of the bent portion caused by deformation of the damper is alleviated.

The channel member may have a lamination structure in which a plurality of plates are laminated. The plurality of plates may include a first plate (e.g., the manifold plates 21E, 21F, and 21G), a second plate (e.g., the cover plate 21H), a third plate (e.g., the cover spacer plate 211), and a fourth plate (e.g., the nozzle plate 21J). The first plate may form the common channel. The second plate may include a recessed portion (e.g., the recessed portion 64c) that is a portion of the damper chamber at a position corresponding to the common channel, of a surface on an opposite side to a contact surface with the first plate. The third plate may include a hole (e.g., the hole 64d) forming the damper chamber together with the recessed portion. The fourth plate may be configured to seal the hole and form the bottom wall of the damper chamber. The damper may be formed by a remaining portion remaining at a position of the recessed portion in a thickness direction of the second plate. As a result, according to the liquid discharge head of the embodiment, the recessed portion and the damper can be simultaneously formed by half-etching the second plate.

The thick portion may be formed by overlapping a region of the third plate, excluding the hole, with the fourth plate. As a result, according to the liquid discharge head of the embodiment, the rigidity of the thick portion can be improved.

Further effects and variations can be readily derived by those skilled in the art. Thus, a wide variety of aspects of the present invention are not limited to the specific details and representative embodiments represented and described above. Accordingly, various changes are possible without departing from the spirit or scope of the general inventive concepts defined by the appended claims and their equivalents.

1. A liquid discharge head comprising:
a channel member comprising a first surface and a second surface located on an opposite side to the first surface; and
a pressurizer located on the first surface, wherein
the channel member comprises
a plurality of discharge holes located at the second surface,
a plurality of pressurizing chambers, each connected to respective one of the plurality of discharge holes
a common channel connected to the plurality of pressurizing chambers, and
a damper chamber separated from the common channel with a damper, and comprising:
a bottom wall facing the damper, and comprising:
a first portion having a first thickness; and
a second portion other than the first portion, having a second thickness no more than the first thickness.

2. The liquid discharge head according to claim 1, wherein
the first portion is next to a third portion where a channel direction of the common channel changes.

3. The liquid discharge head according to claim 2, wherein
a sidewall surface of the third portion comprises a corner portion having an acute angle.

4. The liquid discharge head according to claim 2, wherein
the common channel is intersecting in the third portion.

5. The liquid discharge head according to claim 1, wherein
the damper chamber comprises a first section and a second section separated from the first section, and
a communication path is connected to the first section and the second section.

6. The liquid discharge head according to claim 1, wherein
a third portion where a channel direction of the common channel changes comprises a bent portion in which the common channel is bent, and
a width of the bent portion is larger than a width of a region, of the damper chamber and the damper, corresponding to the bent portion.

7. The liquid discharge head according to claim 1, wherein
the channel member further comprises a lamination structure having a plurality of plates are laminated,
the plurality of plates comprises
a first plate that is a portion of the common channel,
a second plate comprising a recessed portion that is a portion of the damper chamber at a position corresponding to the common channel, of a surface on an opposite side to a contact surface with the first plate,
a third plate comprising a hole that is a portion of the damper chamber together with the recessed portion, and
a fourth plate, configured to seal the hole, that is a portion of forming the bottom wall of the damper chamber, and
the damper comprises a remaining portion at a position of the recessed portion in a thickness direction of the second plate.

8. The liquid discharge head according to claim 7, wherein
the first portion comprises a region in which the third plate excluding the hole, and the fourth plate.

9. A recording device comprising:
the liquid discharge head according to claim 1.
